(19) United States
(12) Patent Application Publication
(10) Pub. No.: US 2025/0245718 A1
(43) Pub. Date: Jul. 31, 2025

(54) SYSTEMS AND METHODS FOR ANALYZING IMAGING OBTAINED FROM BACKGROUND ACCESS TO A CAMERA

(71) Applicant: Capital One Services, LLC, McLean, VA (US)

(72) Inventors: Justin AU-YEUNG, Alexandria, VA (US); Galen RAFFERTY, Mahomet, IL (US); Michael DAVIS, Arlington, VA (US)

(73) Assignee: Capital One Services, LLC, McLean, VA (US)

(21) Appl. No.: 18/425,626

(22) Filed: Jan. 29, 2024

(51) Int. Cl. G06Q 30/0601; G06V 20/60

(52) U.S. Cl. CPC G06Q 30/0631; G06V 20/60

(57) ABSTRACT

A method for analyzing imaging obtained from background access to a camera may include detecting, via a first electronic application (the “FEA”) operating on a device, that a second electronic application (the “SEA”) operating on the device, separate from the FEA, is accessing the camera of the device to observe an item identifier (the “II”) of a physical item (the “PI”) to be added to a collection of PIs; extracting, via the FEA, the II from imaging data captured by the camera; determining, via the FEA, a value of the PI based on the extracted II; determining, via the FEA, a total value of the collection based on the value; generating, via the FEA, at least one status assessment of a user associated with the device based on the total value; and executing, via the FEA, at least one action based on the at least one status assessment.

### TECHNICAL FIELD

Various embodiments of this disclosure relate generally to techniques for analyzing imaging data, and, more particularly, to systems and methods for using background access to a camera being used by another application in order to provide analysis of an addition to a collection of items.

### BACKGROUND

Budgeting tools have become widely prevalent as a technique to assist with financial planning. Further, the availability of online shopping has made the usability of savings tools like comparison shopping tools easier and more prevalent. However, many of these tools are not available when making purchases in person. Many physical stores not only benefit from unequal access to pricing information, but also structure their venues so as to incite impulsive behaviors. At the same time, the spread of automation has resulted in many physical venues relying on the customers themselves to scan and check-out their purchases.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems for analyzing imaging obtained from background access to a camera are disclosed. Each of the examples disclosed herein may include one or more features described in connection with any of the other disclosed examples.

In one aspect, an exemplary embodiment of a method for analyzing imaging obtained from background access to a camera is disclosed. The method may include detecting, via a first electronic application operating on a device, that a second electronic application operating on the device, separate from the first electronic application, is accessing the camera of the device to observe an item identifier of a physical item to be added to a collection of physical items. The method may also include extracting, via the first electronic application, the item identifier from imaging data captured by the camera. The method may include determining, via the first electronic application, a value of the physical item based on the extracted item identifier; and determining, via the first electronic application, a total value of the collection of physical items based on the determined value of the physical item. The method may include generating, via the first electronic application, at least one status assessment of a user associated with the device based on the total value of the collection of physical items. In addition, the method may include executing, via the first electronic application, at least one action based on the at least one status assessment of the user.

In another aspect, an exemplary embodiment of a computer-implemented method for analyzing imaging obtained from background access to a camera is disclosed. The method may include accessing one or more of location data of a positioning sensor on a user device or network connection data of the user device. The method may also include identifying an entity associated with the one or more of the location data or the network connection data. The method may include detecting, via a first electronic application operating on the user device, that a second electronic application operating on the user device, separate from the first electronic application, is accessing the camera of the user device to observe an item identifier of a physical item to be added to a collection of physical items. Further, the method may include extracting, via the first electronic application, the item identifier from imaging data captured by the camera. The method may include determining, via the first electronic application, a value of the physical item based on the extracted item identifier by accessing a database of values of items at the identified entity, and identifying the value of the physical item based on the extracted item identifier. The method may include determining, via the first electronic application, a total value of the collection of physical items based on the determined value of the physical item. The method may include generating, via the first electronic application, at least one status assessment of the user based on the total value of the collection of physical items. In addition, the method may include executing, via the first electronic application, at least one action based on the at least one status assessment of the user.

In a further aspect, an exemplary embodiment of a mobile device for analyzing imaging obtained from background access to a camera is disclosed. The mobile device may include at least one memory storing instructions, the camera, and at least one processor operatively connected to the camera and to the at least one memory. The at least one processor may be configured to execute the instructions to perform operations, including, for example, detecting, via a first electronic application operating on the mobile device, that a second electronic application operating on the mobile device, separate from the first electronic application, is accessing the camera of the mobile device to observe an item identifier of a physical item to be added to a collection of physical items. The operations may include extracting, via the first electronic application, the item identifier from imaging data captured by the camera. The operations may include determining, via the first electronic application, a value of the physical item based on the extracted item identifier. The operations may include determining, via the first electronic application, a total value of the collection of physical items based on the determined value of the physical item. In addition, the operations may include generating, via the first electronic application, at least one status assessment of a user associated with the mobile device based on the total value of the collection of physical items. Generating the at least one status assessment of the user may include accessing information indicative of a status of the user; evaluating an impact of the total value of the collection of physical items on the status; and executing, via the first electronic application, at least one action based on the at least one status assessment of the user.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for analyzing imaging obtained from background access to a camera, according to one or more embodiments.

FIG. 2 depicts a flowchart of an exemplary method of analyzing imaging obtained from background access to a camera, according to one or more embodiments.

FIG. 3 depicts an example of a computing device, according to one or more embodiments.

### DETAILED DESCRIPTION OF EMBODIMENTS

According to certain aspects of the disclosure, methods and systems are disclosed for analyzing imaging data, and, more particularly, to methods and systems for analyzing imaging obtained from background access to a camera

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. Any suitable type of training may be used, e.g., stochastic, gradient boosted, random seeded, recursive, epoch or batch-based, etc.

Terms like “provider,” “merchant,” “vendor,” “venue,” or the like generally encompass an entity or person involved in providing, selling, and/or renting items to persons such as a seller, dealer, renter, merchant, vendor, or the like, as well as an agent or intermediary of such an entity or person. An “item,” “element,” or the like generally encompasses a good, service, or the like having ownership or other rights that may be transferred. As used herein, terms like “user,” “person,” or “customer” generally encompasses any person or entity that may desire an item, information, or any other suitable type of interaction with an entity. The term “browser extension” may be used interchangeably with other terms like “program,” “electronic application,” or the like, and generally encompasses software that is configured to interact with, modify, override, supplement, or operate either independently or in conjunction with other software, e.g., as a client operating with a server or the like.

In an exemplary use case, a user may shop at a grocery store (or other brick-and-mortar store) while carrying a user device (e.g., a smartphone, tablet, etc.) and pushing a shopping cart. A first electronic application and a second electronic application may operate on the user device. The second electronic application, e.g., an application associated with the grocery store, may access a camera (and/or image data captured by the camera) of the user device. As the user walks through the grocery store, the user may use the second electronic application to cause the camera of the user device to image (e.g., take a photo or video of, or scan) an item offered by the grocery store, e.g., a loaf of bread, or signage associated with the loaf of bread, before placing the loaf in the user's shopping cart. In some aspects, the captured image (or image data) may include or represent an item identifier of the item. The item identifier may be, for example, a shape or appearance of the loaf, text, a trademark, a barcode, or other visual information, presented on the packaging of the loaf of bread, or on signage proximate to the loaf. While the second electronic application accesses the camera, the first electronic application may access the captured image data of the loaf to extract the loaf's item identifier in a manner that is opaque to (or undetected by) the second electronic application. The first electronic application may further use the item identifier to determine, for example, that the value (or price) of the loaf of bread is $5.

After placing the loaf in the shopping cart, the user may continue to walk through the grocery store. The user may then use the second electronic application to image a further item such as a can of soup before placing the can in the user's shopping cart. While the user images the can of soup, the first electronic application may access image data of the can captured by the camera, and extract the can's item identifier from the image data. The first electronic application may then use the can's item identifier to determine that the value (or price) of the can of soup is $4.

As the user proceeds through the grocery store, the user may come across a blender, which the user images using the second electronic application, and then places in the shopping cart. While the user images the blender, the first electronic application may access image data of the blender captured by the camera. The first electronic application may extract the item identifier from the image data, and use the extracted item identifier to determine that the value (or price) of the blender is $120. The first electronic application may further determine that the total value of all the items the user has placed in the shopping cart is $129 (or the sum of $5 for the loaf of bread, $4 for the can of soup, and $120 for the blender). In addition, the first electronic application may generate at least one status assessment of the user based on the total value ($129) of the items placed in the shopping cart. For example, the first electronic application may generate a status assessment indicating that the total value of the items placed in the user's shopping cart ($129) exceeds the user's budget of $100. Subsequently, the first electronic application may generate a recommendation (or notification) for display on the user device, indicating that the user should remove the blender from the shopping cart (or not proceed to purchase the blender) in order to adhere to the user's budget of $100. In addition, or in the alternative, the recommendation may indicate that the blender should be purchased at another grocery store (or other physical or online store) for a lower price (e.g., $91).

As described above, when users shop in physical stores, users often do not have access to tools for budgeting and/or comparing the prices of one or more items available at multiple stores. However, aspects of the present disclosure provide processes for analyzing, in near real time, imaging data of items a user wishes to purchase while shopping at a physical store, and, for example, generating a recommendation to remove or exchange at least one item in the user's shopping cart, and/or to purchase at least one of the items in the shopping cart at a lower price elsewhere. Accordingly, the techniques described herein support a user's financial planning by helping the user make prudent buying decisions.

While several of the examples above involve shopping or obtaining items from a physical vendor or entity, it should be understood that techniques and technologies disclosed herein may be adapted to any suitable activity involving collecting items, such as navigating to various stores in a mall, etc.

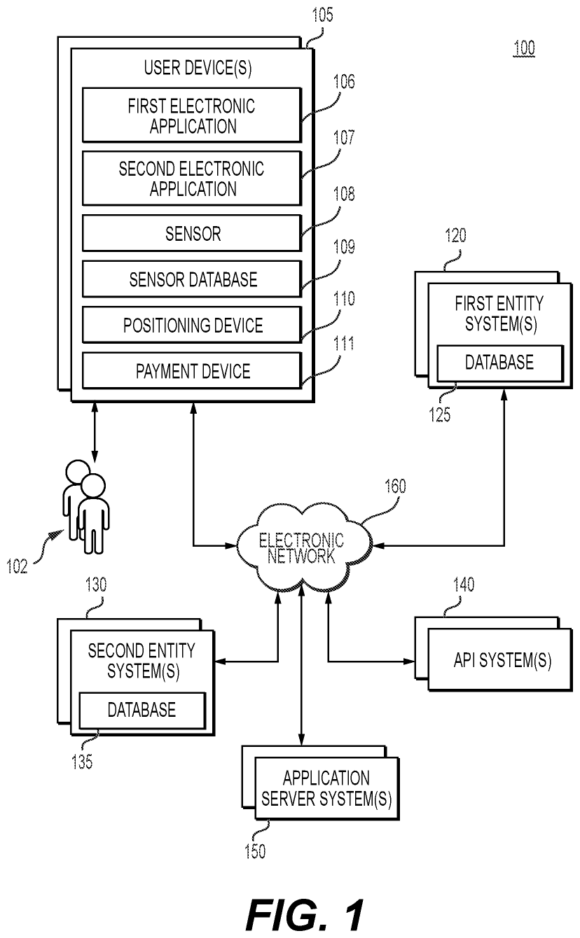

FIG. 1 depicts an exemplary environment 100 that may be utilized with techniques presented herein. One or more user device(s) 105, one or more first entity system(s) 120, one or more second entity system(s) 130, one or more application programming interface (“API”) system(s) 140, and one or more application server system(s) 150 may communicate with one another in any arrangement, across an electronic network 160. Although the one or more user device(s) 105, the one or more first entity system(s) 120, the one or more second entity system(s) 130, the one or more API system(s) 140, and the one or more application server system(s) 150 may be included in various embodiments, for simplicity of description, such elements are referred to in the singular. Any number of such elements may be used in various embodiments. In some aspects, a user 102 may be associated with (e.g., own, carry and/or be proximate to) the user device 105.

In some embodiments, the user device 105 may be configured to enable the user 102 to access and/or interact with other systems in the environment 100. For example, the user device 105 may be a computer system such as, for example, a mobile device, a tablet, etc. As shown in FIG. 1, the user device 105 may include a first electronic application 106, a second electronic application 107, a sensor 108, a sensor database 109, a positioning device 110, and a payment device 111. In some aspects, the first electronic application 106 may be a program, plugin, browser extension, add on, etc., installed on a memory of the user device 105 and/or a memory of the application server system 150. In some embodiments, the first electronic application 106 may be associated with the first entity system 120 and/or a financial institution, bank, etc. associated with the first entity system 120. The first electronic application 106 may be configured to provide, in real time (or near real time), a budget evaluation and/or financial guidance to the user 102 while the user 102 shops in a physical store associated with the second entity system 130.

The second electronic application 107 may be a program, plugin, browser extension, add on, etc., installed on a memory of the user device 105, and may be separate from the first electronic application 106. In some embodiments, the second electronic application 107 may be associated with the second entity system 130 and/or a physical store associated with the second entity system 130. Further, the second electronic application 107 may be configured to facilitate scanning a physical item for sale at the physical store. For example, when the user 102 shops at the physical store and holds the user device 105 near (e.g., within a line of sight or range of) a physical item the user 102 wishes to purchase, the second electronic application 107 may control and/or access the sensor 108 and cause the sensor 108 to scan or image the physical item. The second electronic application 107 may also be configured to access the sensor 108 and/or the sensor database 109 to observe (or detect) an item identifier of the physical item being scanned. Further, in some embodiments, the second electronic application 107 may be configured to facilitate payment of the physical item using, for example, the payment device 111.

The sensor 108 may be, for example, one or more of a camera, barcode scanner, infra-red sensor, RFID sensor, or the like. The sensor database 109 may be a memory configured to store data (e.g., image data) captured by the sensor 108. In some embodiments, the sensor 108 may include the sensor database 109. The positioning device 110 may include one or more of a Global Positioning System (“GPS”) sensor device, and/or a wireless antenna usable for location sensing (e.g., a cellular antenna, Bluetooth antenna, wireless network antenna, or the like). In some aspects, the positioning device 110 may be configured to receive, determine, and/or generate location data representing the location of the user device 105. The payment device 111 may be, for example, a Near Field Communication (“NFC”) device or antenna, a Radio Frequency Identification (“RFID”) antenna, or the like. The user device 105 may include any suitable type of interface for interacting with the user 102, such as a touchscreen, a speaker, a microphone, one or more buttons, etc.

The first entity system 120 may include a server system or other computing device associated with, for example, a financial institution, bank, etc. In some aspects, the first entity system 120 may be configured to enable a financial institution to interact with other systems, such as the user device 105, the second entity system 130, the API system 140, and/or the application server system 150, in the environment 100. In some aspects, the user 102 may hold one or more accounts with the financial institution, where each of the one or more accounts may be associated with a respective interaction element such as a credit card, debit card, etc., issued to the user 102 by the financial institution. As shown in FIG. 1, the first entity system 120 may include a database 125 configured to store data associated with the one or more accounts of the user 102. For example, the database 125 may store data representing one or more of historical transactions (e.g., interactions) of the user 102 for obtaining items, historical records of the user 102 (e.g., bank statements, receipts, etc.), or a value allocation plan (e.g., a budget) of the user 102.

The second entity system 130 may include a server system or other computing device associated with a physical store (e.g., a grocery store, department store, etc.). In some aspects, the second entity system 130 may be configured to enable a physical store to interact with other systems, such as the user device 105, the first entity system 120, the API system 140, and/or the application server system 150, in the environment 100. In some embodiments, the physical store may sell one or more items (e.g., food, appliances, clothes, electronics, sporting goods, plants, etc.). As shown in FIG. 1, the second entity system 130 may include a database 135 configured to store data about the one or more items for sale in the physical store. For example, the database 135 may store data representing one or more of the name, manufacturer, bar code, price, trademark, image, etc. of each of the one or more items for sale. In some embodiments, the second entity system 130 may be configured to facilitate one or more transactions (e.g., sales or purchases of item(s)) with the user 102.

The API system 140 may include a server or other computing device, and may be configured to interact with other systems, such as the user device 105, the first entity system 120, the second entity system 130, and/or the application server system 150, in the environment 100. The API system 140 may be configured to receive and respond to a request for information or the like. For example, the API system 140 may include an item-finder service configured to receive information indicative of an identity of an item (e.g., from the first electronic application 106), determine the price of the item (and optionally one or more items identical to, or likely to be similar to, the item and that have lower prices than the item), and provide such information back to the requesting system or entity. In some aspects, the one or more items identical to, or likely to be similar to, the item and that have lower prices than the item, may be for sale at (i) one or more physical stores that are separate from the physical store associated with the second entity system 130, and that are proximate to the user 102, and/or (ii) one or more online stores. To provide such an item-finder service, in various embodiments, the API system 140 may include one or more algorithms, machine learning models, or the like.

In another example, the API system 140 may be configured to obtain and/or parse financial information, payment information, or transaction information associated with the user 102. For instance, the API system 140 may be configured to obtain an electronic receipt associated with the user 102, from, for example, the user device 105, the first entity system 120, the second entity system 130, or the application server system 150. In another instance, the API system 140 may receive a photo of a receipt or other item information, and may be configured to parse such information to determine itemized transaction information (e.g., the price of an item), or the like. Such information determined via the API system 140 may be used, for example, when sourcing information about items provided by various physical stores, or any other suitable purpose.

The application server system 150 may include a server or other computing device, and may be configured to interact with other systems, such as the user device 105, the first entity system 120, the second entity system 130, and/or the API system 140, in the environment 100. As discussed above, in some embodiments, the first electronic application 106 may be installed on a memory of the user device 105 and/or the application server system 150.

In an exemplary use case, a user 102 may shop at a physical store (e.g., a grocery store) associated with the second entity system 130, while carrying the user device 105 and pushing a shopping cart. The first electronic application 106 and the second electronic application 107 may operate on the user device 105. The second electronic application 107 (e.g., an application associated with the grocery store) may access the sensor 108 (and/or image data of the sensor database 109) of the user device 105. As the user walks through the grocery store, the user may use the second electronic application 107 to cause the sensor 108 (e.g., a camera) of the user device 105 to image (e.g., take a photo or video of, or scan) a box of dried spaghetti offered by the grocery store, before placing the box in the user's shopping cart. The item identifier may be, for example, a shape or appearance of the box of dried spaghetti, text, a trademark, a barcode, or other visual information associated with the box. In some aspects, image data of the box of dried spaghetti captured by the sensor 108 may be stored in the sensor database 109. While the second electronic application 107 accesses the sensor 108, the first electronic application 106 (e.g., stored on a memory of the application server system 150) accesses the sensor database 109 to extract, for example, the barcode of the box from the captured image data without being detected by the second electronic application 107. Further, the first electronic application 106 may use the barcode to determine, in near real time, that the value (or price) of the box of dried spaghetti is $4.

For example, the first electronic application 106 may access the positioning device 110 to obtain location data of the user device 105 and transmit the location data and barcode to the API system 140. In some other embodiments, the first electronic application 106 may access network connection data of the user device 105 to obtain the location data. The API system 140 may use the location data to determine that the user 102 is shopping at the grocery store (a store at a particular location). Subsequently, the API system 140 may determine that the grocery store is associated with the second entity system 130. The API system 140 may then access the database 135 (which includes data regarding one or more items sold in the grocery store) to determine that the bar code is associated with a box of dried spaghetti priced at $4. The API system 140 may subsequently transmit the price of the box of dried spaghetti ($4) to the first electronic application 106. In some other embodiments, the first electronic application 106 may communicate directly with the second entity system 130 and/or the database 135 to determine the price ($4) associated with the barcode.

As the user 102 continues to walk through the grocery store, the user 102 sees a jar of tomato sauce. The user 102 subsequently uses the second electronic application 107 to image the jar using the sensor 108, before placing the jar in the user's shopping cart. While the user 102 images the jar, the first electronic application 106 may access image data of the jar stored in the sensor database 109 (without detection by the second electronic application 107) to extract, for example, a barcode of the jar of tomato sauce. As described above, the first electronic application 106 may then use the bar code to determine that the value (or price) of the jar of tomato sauce is $5.

As the user 102 proceeds through the grocery store, the user 102 may come across a package of cigars. The user 102 may use the second electronic application 107 to image the package of cigars using the sensor 108, before placing the package in the user's shopping cart. While the user 102 images the package, the first electronic application 106 may access image data of the package stored in the sensor database 109 (without detection by the second electronic application 107) to extract, for example, a barcode of the package. As described above, the first electronic application 106 may then use the bar code to determine that the value (or price) of the package of cigars is $40. The first electronic application 106 may also determine that the total value of the collection of items in the user's shopping cart is $49 (or the sum of $4 for the box of dried spaghetti, $5 for the jar of tomato sauce, and $40 for the package of cigars).

In some embodiments, the first electronic application 106 may generate at least one status assessment (or evaluation) of the user 102 based on the total value of the items in the user's shopping cart ($49). To generate the at least one status assessment, the first electronic application 106 may first access information indicative of a status of the user 102 from, for example, the first entity system 120, the user device 105, the API system 140, and/or the application server system 150. For example, the first electronic application 106 may access the database 125 of the first entity system 120 (or another system in the environment 100) to obtain data associated with one or more historical transactions (or interactions) of the user 102, historical records (e.g., bank statements, receipts, etc.) of the user 102, and/or a value allocation plan (e.g., a budget, a credit limit, etc.) of the user 102. Further, in some embodiments, the first electronic application 106 may determine, based on the data obtained from the database 125 (or another system in the environment 100), spending patterns or trends of the user 102, such as how often and/or when the user 102 purchases one or more physical items. As another example, the first electronic application 106 may access data from the user device 105 (or another system in the environment 100) indicating the user 102's degree of preference for various items sold at the grocery store. For example, the data may indicate that the user 102 has a strong preference for a box of dried spaghetti and a jar of tomato sauce, and a medium preference for a package of cigars. In some embodiments, the first electronic application 106 may access criteria or other data indicating a status of the user 102 from, for example, a user profile stored on the user device 105 or another system of the environment 100.

Once the first electronic application 106 accesses the information indicative of the status of the user 102, the first electronic application 106 may evaluate an impact of the total value of the collection of items ($49) (and/or the impact of one or more items) in the user's shopping cart on the status. For example, if the user 102 has a budget of $50, the first electronic application 106 may determine that the total value of the collection of physical items in the shopping cart ($49) falls within the budget, and thus the user 102's status is acceptable (or not of concern). By contrast, if the user 102 has a budget of $15, the first electronic application 106 may determine that the total value of the collection of items in the shopping cart ($49) exceeds the budget, and thus the user 102's status is not acceptable (or of concern). As another example, if historical transactions of the user 102 reflect that the user 102 generally spends only $20 at the grocery store, the first electronic application 106 may determine that the total value of the collection of items in the shopping cart ($49) is unusual, and that the user 102's status is not acceptable (or of concern). Further, in some embodiments, the first electronic application 106 may determine that (i) the user 102 typically purchases an item (e.g., a jar of tomato sauce) in the user 102's shopping cart only once a month (or another period of time), (ii) it is currently premature for the user 102 to purchase the item, and (iii) the user 102's status is thus of concern. As another example, if the first electronic application 106 determines that the user 102 has a credit limit of $40, the first electronic application 106 may determine that the total value of the collection of items in the shopping cart ($49) exceeds the credit limit, and thus the user 102's status is of concern. As yet another example, where the first electronic application 106 determines that the user 102 has only $40 in the user's account with the financial institution, the first electronic application 106 may determine that the user 102's status is not acceptable. It is noted that the statuses described herein are illustrative only, that a status may be qualitative and/or quantitative, and that any suitable criteria or rubric for assigning a status may be used with the disclosed embodiments.

In some embodiments, the first electronic application 106 may evaluate an impact of the total value of the collection of items in the user 102's shopping cart ($49) (or the impact of one or more items in the user 102's shopping cart) on the status when the total value equals a certain percentage (or is within a particular range) of the user 102's budget. In addition, or in the alternative, the first electronic application 106 may evaluate an impact of the total value of the collection of items in the user's shopping cart ($49) (or the impact of one or more items in the user 102's shopping cart) on the status when a particular (e.g., threshold, minimum, maximum, etc.) number of physical items are included in the collection, and/or when the total value of the collection reaches a particular value. Further, in some embodiments, the first electronic application 106 may evaluate an impact of the total value of the collection of items in the user 102's shopping cart ($49) (or the impact of one or more items in the user 102's shopping cart) on the status after each respective item is placed in the shopping cart or after the addition of one or more items to the shopping cart causes a threshold change in the total value of the collection of items in the shopping cart.

In some embodiments, at least one action may be executed via the first electronic application 106 based on the at least one status assessment of the user 102. For example, the at least one action may include generating a recommendation (e.g., data representing a recommendation) for removal or exchange of at least one item in the collection of items in the shopping cart based on, for example, the user 102's historical spending patterns (e.g., a determination that it would be premature for the user 102 to purchase the at least one item). In some embodiments, the at least one action may include generating a recommendation to exchange at least one item in the collection of items for at least one other item in the grocery store based on at least one status assessment of the user and a determination by the first electronic application 106 that the exchange is feasible (e.g., that the at least one other item is in stock at the grocery store). Further, in some embodiments, once the at least one item has been exchanged for the at least one other item, the first electronic application 106 may not generate any subsequent recommendation to remove or exchange the at least one other item. In some embodiments, the at least one action may include generating a recommendation to remove at least one item in the collection of items based on at least one status assessment of the user 102 and a determination by the first electronic application 106 that an exchange of the at least one item is not feasible (e.g., that at least one other item is not in stock at the grocery store).

In some embodiments, a recommendation may be determined based on a change in the total value of the collection of items resulting from the removal or exchange. The recommendation may indicate, for example, that the user 102 should remove the $40-package of cigars from the shopping cart (or not purchase the package) because doing so would reduce the total value of the collection of items ($49) by $40, and conform with the user's budget of $20. In addition, or in the alternative, the recommendation may indicate that the user 102 should remove the $40-package of cigars from the shopping cart because the user 102 has only a medium preference for the package and a much stronger preference for the box of dried spaghetti and jar of tomato sauce (where such preferences or criteria may be derived from a user profile of the user 102, for example).

The recommendation may also, or in the alternative, indicate that the user 102 should remove the $40-package of cigars from the shopping cart (or not purchase the package) because there is a relatively weak association between the package and the box of dried spaghetti (or the jar of tomato sauce), while there is a strong association between the box of dried spaghetti and the jar of tomato sauce. In some embodiments, where a predetermined threshold (e.g., a numerical threshold) represents, for example, a satisfying meal, the first electronic application 106 may determine that the association between the box of cigars and the dried box of spaghetti (and/or the jar of tomato sauce) is below the predetermined threshold, and that the association between the dried box of spaghetti and the jar of tomato sauce meets or exceeds the predetermined threshold; and consequently the first electronic application 106 may cause a recommendation indicating that the box of cigars should not be purchased, to be generated. Stated differently, the first electronic application 106 may use, for example, a grouping algorithm to determine that (i) the box of dried spaghetti and jar of tomato sauce form a first group because these items are related or complimentary (e.g., often purchased or consumed together as a meal), (ii) the box of cigars forms a second group by itself, and (iii) that the first group is associated a higher ranking (or is more desirable) than the second group. Accordingly, the first electronic application 106 may cause the generation of a recommendation indicating that only the first group should be purchased because of its higher rank. Similarly, in some embodiments, the first electronic application 106 may determine that the box of dried spaghetti and jar of tomato sauce are associated and thus form a group, and that the box of cigars is unlinked or unassociated with the group. Consequently the first electronic application 106 may cause the generation of a recommendation to not purchase the box of cigars (or to prioritize removal of a physical item unlinked to a larger group). Further, in some embodiments, the recommendation may indicate that the user 102 should remove the package of cigars from the shopping cart because the package is associated with a particular characteristic or category (e.g., an unhealthy item, a luxury item, or impulse purchase). In some aspects, the recommendation may be presented on a display screen of the user device 105.

In some embodiments, the at least one action may include generating a notification (e.g., data representing the notification) that the impact on the status of the user 102 exceeds available value (e.g., funds, credit limit, etc.) of the user 102 as indicated by one or more historical interactions of the user 102 for obtaining items, historical value records of the user 102, or a value allocation plan of the user 102. The notification may indicate, for example, that the user 102 does not have enough funds in the user 102's account or has insufficient credit to purchase each of the items in the user 102's shopping cart. In addition, or in the alternative, the notification may indicate that the user 102 should wait until the user 102's next paycheck is deposited in the user 102's account before purchasing each of the items in the shopping cart. In some aspects, the notification may be presented on a display screen of the user device 105.

In some embodiments, the at least one action executed via (or using) the first electronic application 106 may include deactivating an interaction element (e.g., a credit card) of the user 102 such that an interaction (or transaction) to obtain the collection of items in the shopping cart using the interaction element is blocked. In some embodiments, where the interaction element is included in the payment device 111, the interaction element may be deactivated locally on the user device 105 (e.g., via an operation or configuration of an NFC antenna, or the like, in the payment device 111). In addition, or in the alternative, the interaction element may be deactivated remotely (e.g., the first electronic application 106 may transmit a request to the financial institution associated with the first entity system 120 to not approve one or more transactions using the interaction element). In addition or in the alternative, the at least one action executed via (or using) the first electronic application 106 may include automatically requesting one or more of a limit increase on an interaction element (e.g., an increase of a limit on a credit card) of the user 102 or an advance (e.g., a cash or credit advance) to the user 102 in order to facilitate the user 102's purchase of the item(s) in the shopping cart. For example, the first electronic application 106 may cause a request for a limit increase (or advance or the like) for the user 102 to be automatically transmitted to the financial institution associated with the first entity system 120. Upon receiving the request, the financial institution may automatically generate and/or execute the limit increase (or advance or the like) based on, for example, a credit check of the user 102, history of the user 102, and/or a determination that the limit increase is less than or equal to a threshold amount, etc.

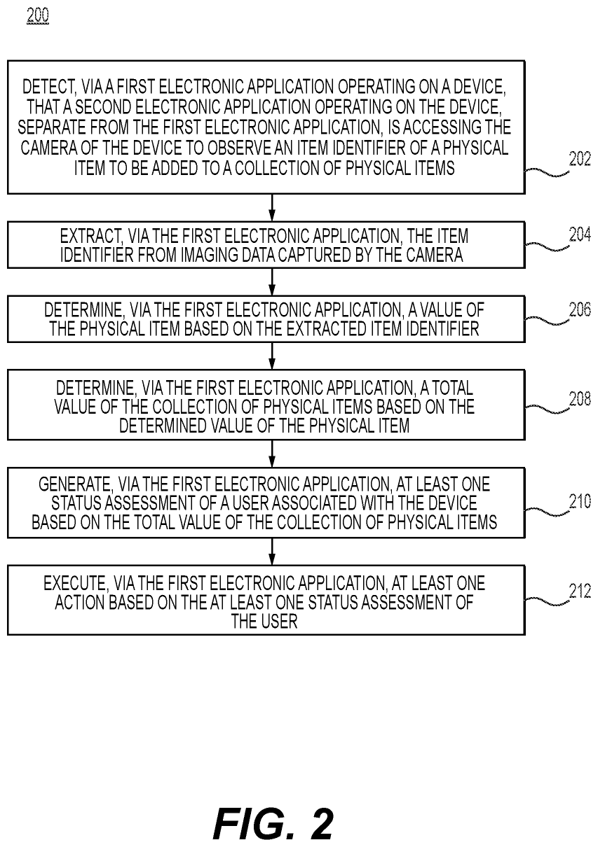

FIG. 2 is a flowchart illustrating a computer-implemented method 200 for analyzing imaging (e.g., image data) obtained from background access to a camera, according to one or more embodiments of the present disclosure. In some aspects, the camera may be an embodiment of the sensor 108 discussed above with reference to FIG. 1. The method 200 may be performed via (or using) the first electronic application 106 discussed above with reference to FIG. 1. In some embodiments, the first electronic application 106 may include one or more machine learning models configured to facilitate the operations of the method 200.

The method 200 may include detecting, via the first electronic application 106 operating on a device (e.g., the user device 105), that a second electronic application (e.g., the second electronic application 107) operating on the device, separate from the first electronic application 106, is accessing the camera of the device to observe an item identifier (e.g., a barcode, etc.) of a physical item to be added to a collection of physical items (step 202). The method 200 may further include extracting, via the first electronic application 106, the item identifier from imaging data captured by the camera (step 204). In some aspects, the extracting of the item identifier from the imaging data captured by the camera is performed so as to be opaque to the second electronic application. The method 200 may further include determining, via the first electronic application 106, a value of the physical item based on the extracted item identifier (step 206). In some embodiments, determining the value of the physical item based on the extracted item identifier may include (i) accessing one or more of location data of a positioning sensor on the device, or network connection data of the device; (ii) based on the one or more of the location data of the positioning sensor or the network connection data of the device, identifying an entity (e.g., a physical store) that is likely providing the collection of physical items to the user; and (iii) accessing a database of values of items at the identified entity, and identifying the value of the physical item based on the extracted item identifier.

The method 200 may further include determining, via the first electronic application 106, a total value of the collection of physical items based on the determined value of the physical item (208). The method 200 may include generating, via the first electronic application 106, at least one status assessment of a user (e.g., the user 102) associated with the device based on the total value of the collection of physical items (210). In some embodiments, generating the at least one status assessment of the user may include accessing information indicative of a status of the user, and evaluating an impact of the total value of the collection of physical items on the status. The information indicative of the status of the user may include, for example, one or more of historical interactions of the user for obtaining items, historical value records of the user, or a value allocation plan of the user.

The method 200 may also include executing, via the first electronic application 106, at least one action based on the at least one status assessment of the user (212). In some embodiments, the at least one action executed by the first electronic application 106 may include generating a recommendation for removal or exchange of at least one item in the collection of physical items. The at least one item of the recommendation may be determined based on one or more of (i) a change in the total value resulting from the removal or exchange; (ii) priority information (e.g., information regarding a priority or preference) for the at least one item relative to at least one other item in the collection of physical items; (iii) a determined association between the at least one item and a remainder of the collection of physical items being below a predetermined threshold; or (iv) a characteristic or category of the at least one item. In some embodiments, the at least one action executed by the first electronic application 106 may include generating a notification that the impact on the status of the user exceeds available value of the user as indicated by the one or more of the historical interactions of the user for obtaining items, the historical value records of the user, or the value allocation plan of the user. Further, in some embodiments, the at least one action executed by the first electronic application 106 may include deactivating an interaction element of the user such that an interaction to obtain the collection of physical items using the interaction element is blocked. In some other embodiments, the at least one action executed by the first electronic application 106 may include automatically requesting one or more of a limit increase on an interaction element of the user or an advance to the user.

It should be understood that embodiments in this disclosure are exemplary only, and that other embodiments may include various combinations of features from other embodiments, as well as additional or fewer features.

In general, any process or operation discussed in this disclosure that is understood to be computer-implementable, such as the processes illustrated in FIG. 2, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

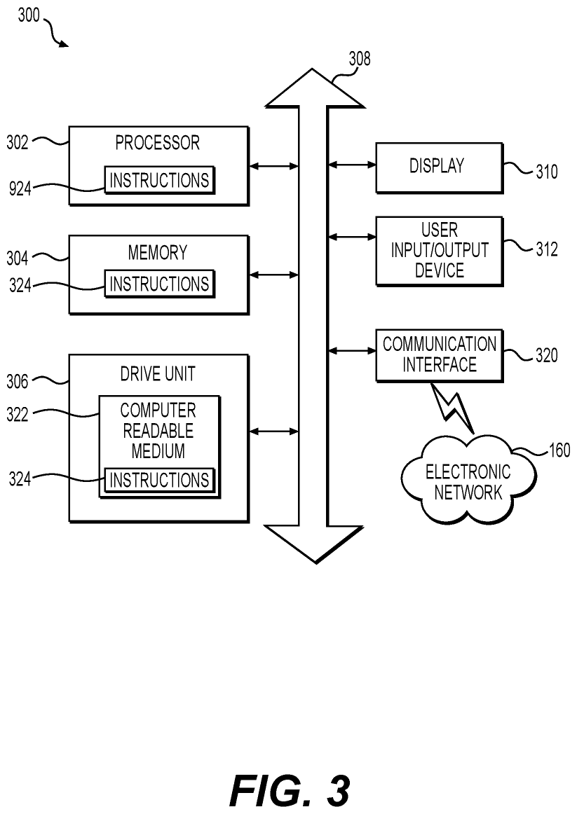

FIG. 3 is a simplified functional block diagram of a computer 300 that may be configured as a device for executing the methods of FIG. 2, according to exemplary embodiments of the present disclosure. For example, the computer 300 may be configured as the user device 105, the first entity system 120, the second entity system 130, the API system 140, the application server system 150, and/or another system according to exemplary embodiments of this disclosure. In various embodiments, any of the systems herein may be a computer 300 including, for example, a data communication interface 320 for packet data communication via the electronic network 160. The computer 300 also may include a central processing unit (“CPU”) 302, in the form of one or more processors, for executing program instructions 924. The computer 300 may include an internal communication bus 308, and a storage unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 and/or computer readable medium 322). The computer 300 also may include input and output ports 312 and/or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for analyzing imaging obtained from background access to a camera, comprising:
detecting, via a first electronic application operating on a device, that a second electronic application operating on the device, separate from the first electronic application, is accessing the camera of the device to observe an item identifier of a physical item to be added to a collection of physical items;
extracting, via the first electronic application, the item identifier from imaging data captured by the camera;
determining, via the first electronic application, a value of the physical item based on the extracted item identifier;
determining, via the first electronic application, a total value of the collection of physical items based on the determined value of the physical item;
generating, via the first electronic application, at least one status assessment of a user associated with the device based on the total value of the collection of physical items; and
executing, via the first electronic application, at least one action based on the at least one status assessment of the user.

2. The computer-implemented method of claim 1, wherein the extracting of the item identifier from imaging data captured by the camera is performed so as to be opaque to the second electronic application.

3. The computer-implemented method of claim 1, wherein the at least one action executed by the first electronic application includes generating a recommendation for removal or exchange of at least one item in the collection of physical items.

4. The computer-implemented method of claim 3, wherein the at least one item of the recommendation is determined based on one or more of:
a change in the total value resulting from the removal or exchange;
priority information for the at least one item relative to at least one other item in the collection of physical items;
a determined association between the at least one item and a remainder of the collection of physical items being below a predetermined threshold; or
a characteristic or category of the at least one item.

5. The computer-implemented method of claim 1, wherein generating the at least one status assessment of the user includes:
accessing information indicative of a status of the user; and
evaluating an impact of the total value of the collection of physical items on the status.

6. The computer-implemented method of claim 5, wherein the information indicative of the status of the user includes one or more of:
historical interactions of the user for obtaining items;
historical value records of the user; or
a value allocation plan of the user.

7. The computer-implemented method of claim 6, wherein the at least one action executed by the first electronic application includes generating a notification that the impact on the status of the user exceeds available value of the user as indicated by the one or more of the historical interactions of the user for obtaining items, the historical value records of the user, or the value allocation plan of the user.

8. The computer-implemented method of claim 6, wherein the at least one action executed by the first electronic application includes deactivating an interaction element of the user such that an interaction to obtain the collection of physical items using the interaction element is blocked.

9. The computer-implemented method of claim 6, wherein the at least one action executed by the first electronic application includes automatically requesting one or more of a limit increase on an interaction element of the user or an advance to the user.

10. The computer-implemented method of claim 1, wherein determining the value of the physical item based on the extracted item identifier includes:
accessing one or more of location data of a positioning sensor on the device, or network connection data of the device;
based on the one or more of the location data of the positioning sensor or the network connection data of the device, identifying an entity that is likely providing the collection of physical items to the user; and
accessing a database of values of items at the identified entity, and identifying the value of the physical item based on the extracted item identifier.

11. A computer-implemented method for analyzing imaging obtained from background access to a camera, comprising:
accessing one or more of location data of a positioning sensor on a user device or network connection data of the user device;
identifying an entity associated with the one or more of the location data or the network connection data;
detecting, via a first electronic application operating on the user device, that a second electronic application operating on the user device, separate from the first electronic application, is accessing the camera of the user device to observe an item identifier of a physical item to be added to a collection of physical items;
extracting, via the first electronic application, the item identifier from imaging data captured by the camera;
determining, via the first electronic application, a value of the physical item based on the extracted item identifier by accessing a database of values of items at the identified entity, and identifying the value of the physical item based on the extracted item identifier;
determining, via the first electronic application, a total value of the collection of physical items based on the determined value of the physical item;
generating, via the first electronic application, at least one status assessment of the user based on the total value of the collection of physical items; and
executing, via the first electronic application, at least one action based on the at least one status assessment of the user.

12. The computer-implemented method of claim 11, wherein the extracting of the item identifier from imaging data captured by the camera is performed so as to be opaque to the second electronic application.

13. The computer-implemented method of claim 11, wherein the at least one action executed by the first electronic application includes generating a recommendation for removal or exchange of at least one item in the collection of physical items.

14. The computer-implemented method of claim 13, wherein the at least one item of the recommendation is determined based on one or more of:
a change in the total value resulting from the removal or exchange;
priority information for the at least one item relative to at least one other item in the collection of physical items;
a determined association between the at least one item and a remainder of the collection of physical items being below a predetermined threshold; or
a characteristic or category of the at least one item.

15. The computer-implemented method of claim 11, wherein generating the at least one status assessment of the user includes:
accessing information indicative of a status of the user; and
evaluating an impact of the total value of the collection of physical items on the status.

16. The computer-implemented method of claim 15, wherein the information indicative of the status of the user includes one or more of:
historical interactions of the user for obtaining items;
historical value records of the user; or
a value allocation plan of the user.

17. The computer-implemented method of claim 16, wherein the at least one action executed by the first electronic application includes generating a notification that the impact on the status of the user exceeds available value of the user as indicated by the one or more of the historical interactions of the user for obtaining items, the historical value records of the user, or the value allocation plan of the user.

18. The computer-implemented method of claim 16, wherein the at least one action executed by the first electronic application includes deactivating an interaction element of the user such that an interaction to obtain the collection of physical items using the interaction element is blocked.

19. The computer-implemented method of claim 16, wherein the at least one action executed by the first electronic application includes automatically requesting one or more of a limit increase on an interaction element of the user or an advance to the user.

20. A mobile device for analyzing imaging obtained from background access to a camera, comprising:
at least one memory storing instructions;
the camera; and
at least one processor operatively connected to the camera and to the at least one memory, and configured to execute the instructions to perform operations, including:
detecting, via a first electronic application operating on the mobile device, that a second electronic application operating on the mobile device, separate from the first electronic application, is accessing the camera of the mobile device to observe an item identifier of a physical item to be added to a collection of physical items;
extracting, via the first electronic application, the item identifier from imaging data captured by the camera;
determining, via the first electronic application, a value of the physical item based on the extracted item identifier;
determining, via the first electronic application, a total value of the collection of physical items based on the determined value of the physical item; and
generating, via the first electronic application, at least one status assessment of a user associated with the mobile device based on the total value of the collection of physical items, wherein generating the at least one status assessment of the user includes:
accessing information indicative of a status of the user;
evaluating an impact of the total value of the collection of physical items on the status; and
executing, via the first electronic application, at least one action based on the at least one status assessment of the user.
